(19) United States
(12) Patent Application Publication
(10) Pub. No.: US 2025/0375943 A1
(43) Pub. Date: Dec. 11, 2025

(54) METHOD AND SYSTEM FOR RESIN TRANSFER MOLDING COMPOSITE PARTS

(71) Applicant: Spirit AeroSystems, Inc., Wichita, KS (US)

(72) Inventor: Mark Wadsworth, Wichita, KS (US)

(21) Appl. No.: 18/736,630

(22) Filed: Jun. 7, 2024

(51) Int. Cl. B29C 70/48; B29C 70/30; B29C 70/54; B29C 70/68; B29K 105/08

(52) U.S. Cl. CPC B29C 70/48; B29C 70/30; B29C 70/541; B29C 70/548; B29C 70/683; B29K 2105/08

(57) ABSTRACT

In a method for resin transfer molding (RTM) a composite part, a fiber preform is formed on a transfer plate while the transfer plate is supported on a preforming base outside an RTM mold. The RTM mold can be closed for molding another composite part during forming. The transfer plate and the fiber preform are transferred together from the preforming base to an RTM base of the RTM mold. The RTM mold is closed to enclose the fiber preform in the RTM mold. While the RTM mold is closed, the composite part is formed on the transfer plate in the RTM mold by infusing the fiber preform with resin and curing the infused resin to form the composite part. The RTM mold is then opened, and the transfer plate and composite part are removed together from the mold. The RTM molding process can be isothermal.

### FIELD

This invention relates to the production of composite materials by the process of resin transfer molding (RTM).

### BACKGROUND

Resin transfer molding (RTM) is a composite manufacturing process that involves the infusion of resin into a preformed fiber reinforcement (a “fiber preform”), typically fiberglass or carbon fiber, within a closed mold. The first step in an RTM process is assembling the dry fiber preform. When RTM is used to make large, complex parts (e.g., aerostructures), the conventional process is to assemble the fiber preform directly in an open mold. When the fiber preform is assembled and properly positioned in the mold, the mold is then clamped shut. After assembling a large fiber preform directly in an open mold, the mold and preform are often preheated to a suitable molding temperature before resin infusion. Once the fiber preform has been preheated, the RTM system injects resin under pressure (e.g., a vacuum pump can assist with drawing resin through the mold). The resin flows through the mold, impregnating the fibers and filling all voids, until the desired part geometry is achieved. The mold is then heated to cure the resin. After curing, the mold is opened, and the finished composite part is removed. RTM offers advantages such as high fiber volume fraction, complex part geometries, and consistent quality.

However, there are challenges with adapting RTM for high-rate production of large, complex composite parts. RTM molds are very expensive, and fundamentally, they are designed to facilitate resin infusion and curing. But existing RTM processes for large, complex parts require substantial open mold time between each resin infusion and curing of a composite part. For example, after one part is cured, the mold must cool down before the finished part can be removed. Then after removing the finished part, the manufacturer must assemble the fiber preform in the open mold. The fiber preform assembly process can involve a complex series of sequential steps including wrapping mandrels in fiber material, spraying binder onto the fiber material, locating the fiber-wrapped mandrels in the open mold, and/or laying continuous plies or other fiber material onto the preform structure at the proper positions. During this entire fiber preform assembly process the mold is open and thus not being used for its fundamental functions of resin infusion and curing. Moreover, high performance composite parts may require adherence to strict process conditions, such as achieving an elevated fiber preform temperature, compaction of preform bulk and drying any moisture present prior to resin infusion. So even after the fiber preform is assembled and the mold is closed, additional closed mold pre-processing (e.g., preheating, drying and compaction) of the fiber preform is required before resin infusion can begin. The required open mold time and closed mold pre-processing are substantial impediments to high-rate production.

### SUMMARY

In one aspect, a method for resin transfer molding (RTM) a composite part comprises forming a fiber preform on a transfer plate while the transfer plate is supported on a preforming base. The transfer plate and the fiber preform are transferred together from the preforming base to an RTM base of an RTM mold. The RTM mold is closed to enclose the fiber preform in the RTM mold. While the RTM mold is closed, the composite part is formed on the transfer plate in the RTM mold. Said forming the composite part comprises infusing the fiber preform with resin in the closed RTM mold and curing the infused resin in the closed RTM mold to form the composite part. The RTM mold is opened. The transfer plate and composite part are removed together from the mold.

In another aspect, a resin transfer molding (RTM) system for forming composite parts comprises an RTM mold comprising an RTM base. The RTM mold has an open position and a closed position. A preforming base is outside of the RTM mold. A transfer plate is movable between a preforming position on the preforming base and a molding position on the RTM base. The transfer plate is configured to support a fiber preform constructed on the transfer plate while the transfer plate is in the preforming position. The transfer plate is movable from the preforming position to the molding position when the RTM mold is in the open position to load the fiber preform into the RTM mold. The transfer plate is configured to support the fiber preform in the RTM mold at the molding position while the RTM mold is in the closed position, whereby the transfer plate positions the fiber preform for resin infusion and curing in an RTM process.

Other aspects and features will be apparent hereinafter.

### BRIEF DESCRIPTION OF THE DRAWINGS

FIG. 1 is a schematic diagram of an RTM system in accordance with the present disclosure;

FIG. 2 is a perspective of a preforming base of the RTM system supporting a transfer plate of the RTM system, wherein a portion of the transfer plate is broken away to reveal a support surface of the preforming base;

FIG. 3 is a perspective of an RTM mold of the RTM system;

FIG. 4 is a cross section of the RTM mold with a resin transfer plate supporting a fiber preform loaded therein;

FIG. 4A is an enlarged view of a portion of FIG. 4;

FIG. 5 is a fragmentary top plan view of the RTM mold;

FIG. 6 is a perspective similar to FIG. 2 showing a fiber preform being assembled on the transfer plate;

FIG. 7 is a perspective similar to FIG. 6 showing the fiber preform in a more advanced state of assembly;

FIG. 8 is a perspective showing the completed fiber preform being uncovered and moved on the transfer plate from the preforming base to an RTM base of the RTM mold;

FIG. 9 is an elevation showing a completed fiber preform being moved on the transfer plate from the preforming base onto the RTM base; and

FIG. 10 is a perspective of a composite part completion cell of the RTM system.

Corresponding parts are given corresponding reference characters throughout the drawings.

### DETAILED DESCRIPTION

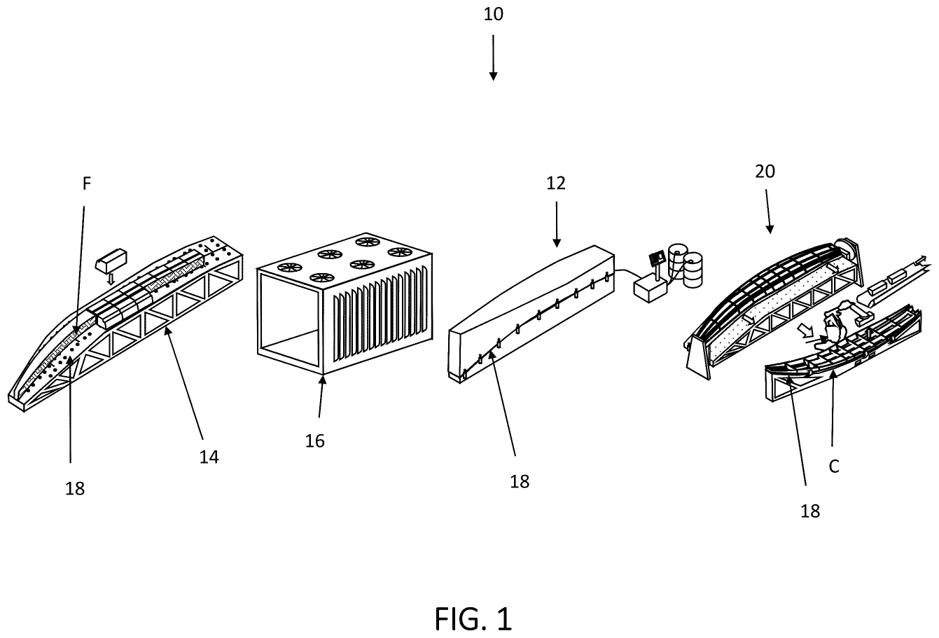

Referring now to FIG. 1, an exemplary embodiment of a resin transfer molding (RTM) system for forming composite parts is shown schematically and generally indicated at reference number 10. The RTM system 10 broadly comprises an RTM mold 12, at least one preforming base 14 outside of the RTM mold, a preheating system 16 outside of the RTM mold, a set of identical transfer plates 18, and a composite part completion cell 20. As will be explained in further detail below, the RTM system 10 is configured to facilitate high-rate production of large, complex composite parts (e.g., aerostructures) by minimizing open mold time and closed mold pre-processing of fiber preforms. More particularly, each preforming base 14 is configured to support a transfer plate 18 outside of the RTM mold so that a fiber preform F can be assembled on the transfer plate 18 and heated by the pre-heating system 16 while the RTM mold is closed. Furthermore, the preform could be vacuum bagged to the transfer plate 18 to cause it to be compacted and dried at the same time. Subsequently, the pre-assembled, pre-heated fiber preform F can be loaded, together with the underlying transfer plate 18, into the RTM mold 12 for resin infusion and curing. When curing is complete, the transfer plate 18 and composite part C can be moved back onto a preforming base 14 for transport to the composite part completion cell 20 where the formwork for the fiber preform can be disassembled and removed from the composite part. Utilization of the expensive RTM mold is improved because open-mold assembly of the fiber preform and closed-mold preconditioning are eliminated.

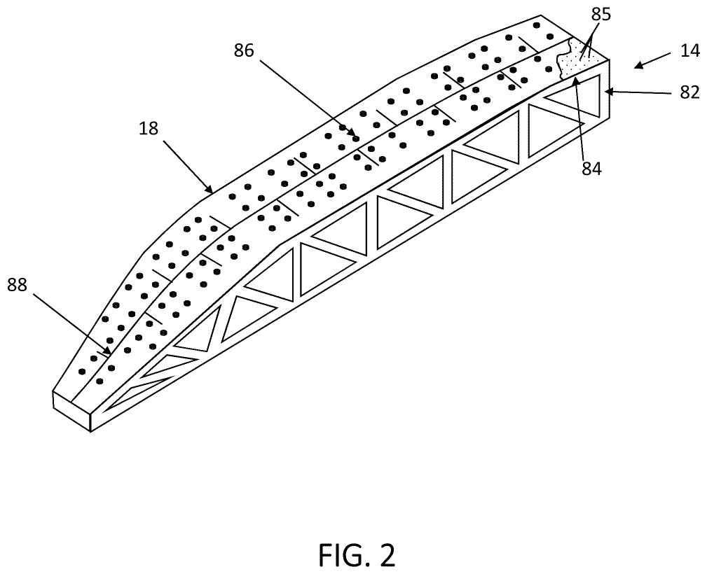

Referring to FIG. 2, each preforming base 14 suitably comprises a chassis 82 and a support surface 84 supported on the chassis. In certain embodiments, the chassis 82 can be a wheeled chassis to enable the preforming base to be rolled from station-to-station within the resin transfer molding system 10. For example, the preforming base 14 can be wheeled from fiber preform assembly area to the preheating system 16, and from the preheating system to the RTM mold 12. In an exemplary embodiment, the preforming base 14 comprises a respective air bearing system. For example, air bearing orifices 85 are formed in the support surface 84 at spaced apart locations along the length and width and a blower (not shown) is configured to blow air through the air bearing orifices 85 to create a cushion of compressed air above the support surface for floating a load (e.g., a transfer plate 18) above the surface.

Each transfer plate 18 is configured to support a fiber preform F during preform assembly, preheating, drying, compaction, resin infusion, and curing. Moreover, each transfer plate 18 is movable between a preforming position on the preforming base 14 and a molding position in the RTM mold 12. In one or more embodiments, the transfer plate 18 is formed from a common, low-cost industrial metal such as steel. In certain embodiments, the transfer plate 18 has a smooth bottom surface that conforms to the shape of the support surface 84 of the preforming base 14. When the air bearing system of the preforming base is turned off, the transfer plate 18 will rest securely on the support surface 84. But when the air bearing system is turned on, the transfer plate 18 will float above the support surface 84 and easily slide from the surface into the open RTM mold 12 (as described more fully below).

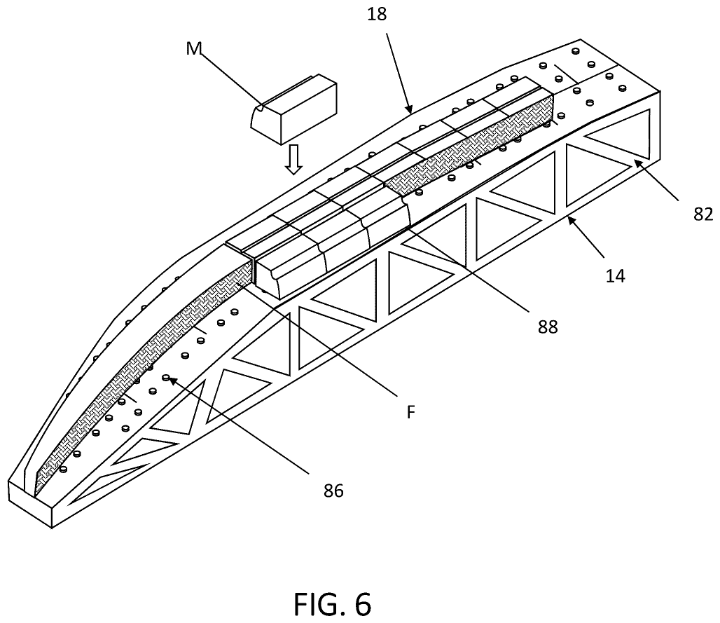

The transfer plate 18 is broadly configured to facilitate construction of a fiber preform F on the transfer plate while the transfer plate is in the preforming position on the preforming base 14. To facilitate preform assembly, the illustrated transfer plate 18 is fitted with indexing formations 86 for locating features of the fiber preform F at predefined positions on the transfer plate. For example, the illustrated indexing formations 86 comprise raised bosses on the top surface of the transfer plate 18 and configured for mating with corresponding recess formed in mandrels M (FIG. 6) used for assembling the fiber preform F. Other transfer plates 18 could comprise other types of indexing formations for aiding in locating the fiber preform at the proper position on the transfer plate.

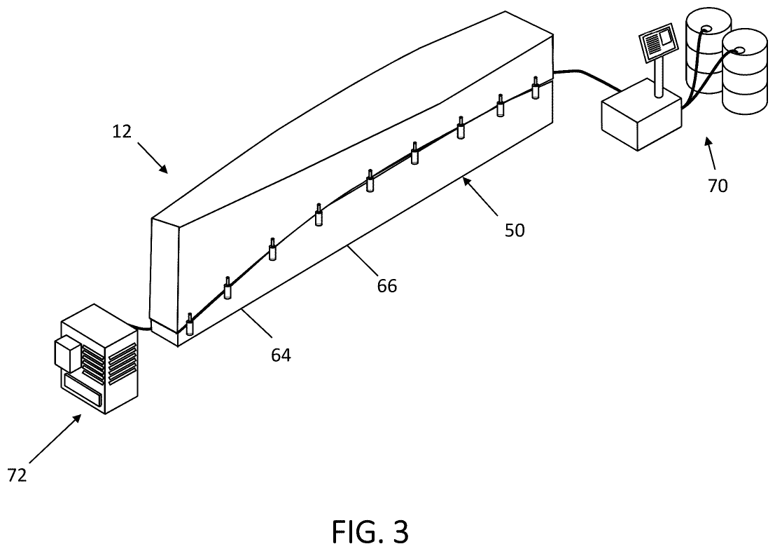

Proper positioning of the fiber preform F on the transfer plate 18 may be important because, in some embodiments, the transfer plate is configured to channel resin from the RTM mold into the fibrous material and/or channel evacuated gas out of the RTM mold during the resin infusion process. In the illustrated embodiment, a resin distribution groove 88 is formed in the top surface of the transfer plate 18. During the RTM process, the resin transfer groove 88 communicates with a resin infusion system 70 of the RTM mold 12 (FIG. 3) such that the resin infusion system 70 pumps resin through the resin transfer groove 88 into the fiber preform F. In certain embodiments, the transfer plate 18 comprises a vacuum distribution groove (not shown) formed in the top surface. During the RTM process, the vacuum distribution groove communicates with a vacuum system 72 of the RTM mold (FIG. 3) to channel evacuated gas out from the RTM mold 12.

Referring again to FIG. 1, it can be seen that the preheating system 16 resides outside of the RTM mold 12. Thus, the preheating system 16 is broadly configured for heating the fiber preform F before the fiber preform is loaded into the RTM mold 12, e.g., while the RTM mold is closed. In general, the preforming base 14 is positionable in relation to the preheating system 16 so that the transfer plate 18 and the fiber preform can be preheated together before loading the fiber preform into the RTM mold 12. As explained below, this allows the RTM mold 12 to conduct an isothermal RTM process (e.g., the RTM mold is maintained at a substantially constant temperature such that the fiber preform F does not need to be heated inside the mold prior to resin infusion). In the illustrated embodiment, the preheating system 16 is an oven. The preforming base 14, transfer plate 18, and fiber preform F are configured to be loaded into the preheating system 16 and heated together. In other embodiments, other types of preheating systems (e.g., induction heating systems) could be used without departing from the scope of the disclosure.

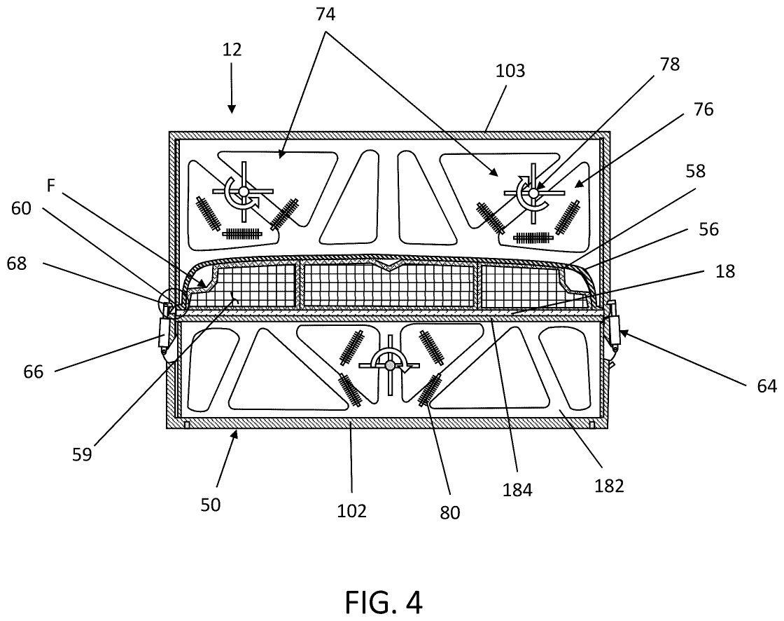

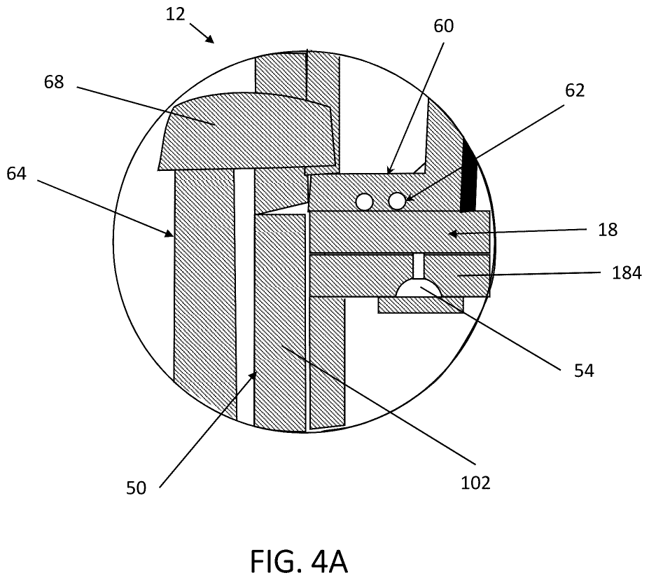

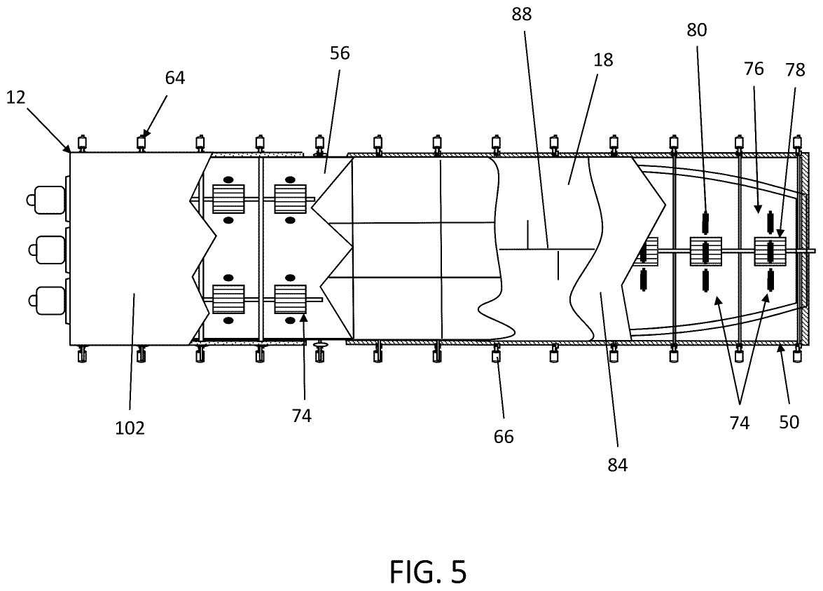

Referring to FIGS. 4-5, the RTM mold 12 broadly comprises an RTM base 50, a mold tool 56, a clamping system 64, a resin infusion system 70 (FIG. 3), a vacuum system 72 (FIG. 3), and an isothermal heating system 74. In general, the RTM mold 12 is adjustable between an open position and a closed position. In the open position, the RTM mold 12 is configured to receive a transfer plate 18 on the RTM base 50 in a molding position, which loads the pre-assembled and pre-heated fiber preform F into the RTM mold. Subsequently the RTM mold 12 is closed so that the RTM mold and the transfer plate 18 together define a mold cavity 59 (e.g., the enclosed space between the mold tool 56 and the transfer plate 18), as shown in FIG. 4. The resin infusion system 70 then infuses resin into the fiber preform F supported on the transfer plate 18 and while vacuum system 72 draws a vacuum in the mold cavity to aid with the distribution of resin through the fiber preform. The resin infusion system 70 and vacuum system 72 can comprise conventional resin pumping and vacuum pump components. But in certain exemplary embodiments, the RTM mold 12 includes integrated resin distribution passaging that fluidly connects the resin infusion system to the resin distribution grooves 88 of the transfer plate 18 when the mold 12 is closed so that at least a portion of the resin pumped from the resin infusion system is distributed through the resin distribution grooves in the transfer plate to the fiber preform F. Likewise, exemplary embodiments of the RTM mold 12 include integrated vacuum distribution passaging that fluidly connects the vacuum system to vacuum distribution grooves (not shown) of a transfer plate when the mold is closed so that at least a portion of the air in the mold cavity is pulled through the vacuum distribution grooves in the transfer plate.

The RTM base 50 has a similar construction to the pre-forming base 14. The RTM base suitably comprises a chassis 182 and a support surface 184 supported on the chassis. In certain embodiments, at least a portion of the support surface 184 of the RTM base 50 has essentially the same shape and arrangement as a corresponding portion of the support surface 84 of the pre-forming base 14. The chassis 182 of the illustrated RTM base 50 is not a wheeled chassis. In the illustrated embodiment, an insulated enclosure 102 is formed around the exterior of the RTM base 50. In an exemplary embodiment, the RTM base 50 comprises an air bearing system. For example, air bearing orifices 54 (FIG. 4A) are formed in the support surface 184 at spaced apart locations along the length and width and a blower (not shown) is configured to blow air through the air bearing orifices to create a cushion of compressed air above the support surface for floating the transfer plate 18 and fiber preform F or composite part on the support surface. One exemplary air bearing orifice 54 is shown in detail in FIG. 4A. The air bearing system of the RTM base 50 and the air bearing system of the preforming base 14 can be turned on at the same time when moving a transfer plate 18 from one base to the other.

The mold tool 56 comprises a tooling surface 58 configured to fit over the fiber preform F (see FIG. 4). In the illustrated embodiment, the mold tool 56 also has a perimeter flange 60 configured to be pressed against a perimeter portion of the transfer plate 18 in the closed position. When closed, the perimeter flange 60 engages the transfer plate 18 at a parting line that extends 360 degrees about the perimeter of the fiber preform. In the illustrated embodiment, the mold tool 56 comprises a gasket 62 on the perimeter flange 60. The gasket 62 on the mold tool is configured to sealingly engage the transfer plate 18 and make a vacuum seal between the transfer plate and the mold tool 56. More particularly, the gasket 62 is compressed against the transfer plate when the RTM mold 12 is closed whereby the gasket seals the parting line so that the RTM mold can maintain a vacuum in the mold cavity 59 between the transfer plate 18 and the mold tool 56.

The clamping system 64 is broadly configured to clamp the mold tool 56 against the transfer plate 18 when the transfer plate is supported on the RTM base 50. Thus, the clamping system 64 secures the RTM mold 12 in the closed position and maintains the vacuum seal of the mold cavity 59. In the illustrated embodiment, the clamping system comprises a plurality of clamping cylinders 66 mounted on the chassis 82 of the RTM base 50. Each clamping cylinder 56 comprises a catch 68 that is configured to engage the top side of the perimeter flange 60 and thereby press the mold tool 56 to clamp the transfer plate 18 against the support surface 184 of the RTM base 50 when the RTM mold 12 is closed. Thereby, the RTM chassis structure carries the bending load created by the pressure in the mold cavity across the span of the RTM mold between opposing clamps without excessively loading the transfer plate 18 with bending reinforcement which would make in unnecessarily heavy.

Referring to FIG. 4, the heating system 74 is preferably an always-on (e.g., isothermal) heating system that maintains the support surface 184 of the RTM base 50 and the tooling surface 58 of the mold tool 56 at an elevated temperature at all times. In the illustrated embodiment, the heating system 74 comprises one or more heaters 76 extending along the length of the RTM mold 12 below the support surface 184 of the RTM base and one or more heaters 76 extending along the length of the RTM mold above the mold tool 56. As explained above, the RTM base 50 comprises an insulated enclosure 50 that insulates a lower space in which some of the heaters 76 are contained below the support surface 184. Likewise, the RTM mold 12 comprises an upper insulated enclosure 103 that insulates an upper space in which others of the heaters 76 are located above the mold tool 56. In the illustrated embodiment, each heater 76 comprises an elongate centripetal blower 78 extending along the length of the RTM mold 12 and heating elements 80 disposed along the length of the blower in the path of air flow from the blower to either the support surface 184 or the mold tool 56, as well as the RTM chassis to cause the entire tool to thermally expand uniformly and not distort because of thermal gradients. It can be seen, that the heaters 76 are configured to direct high velocity heated air toward the respective surfaces to heat the surfaces by convection. As compared with other heating approaches, this convection heating arrangement is thought to reduce control and heating costs.

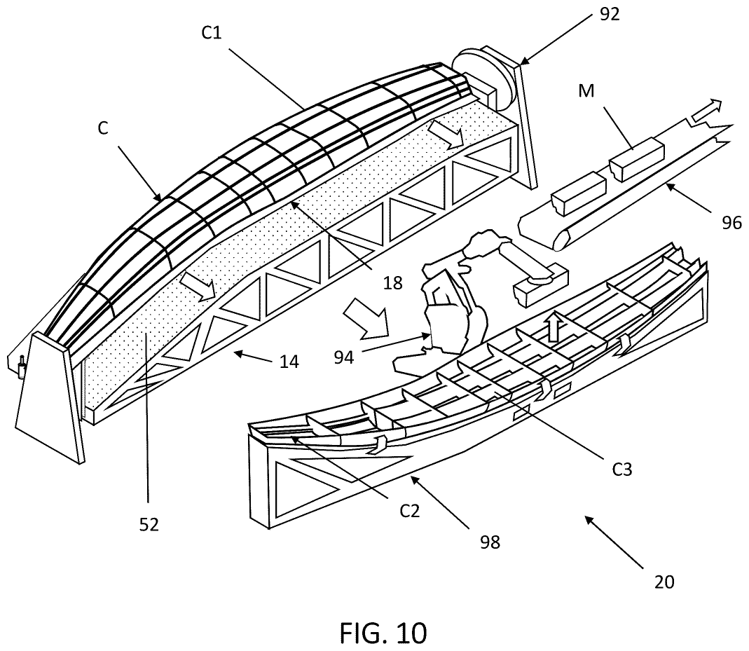

Referring to FIG. 10, the illustrated composite part completion cell 20 comprises a rotator 60 configured to invert the composite part C and transfer plate 18 onto a composite part disassembly base 98. The composite part completion cell 20 further comprises a robot 94 configured to remove the mandrels M from the composite part C onto a conveyor 96. The conveyor 96 is configured to convey the removed mandrels M to a separate area where they can be cleaned (e.g., by carbon dioxide blasting) for reuse.

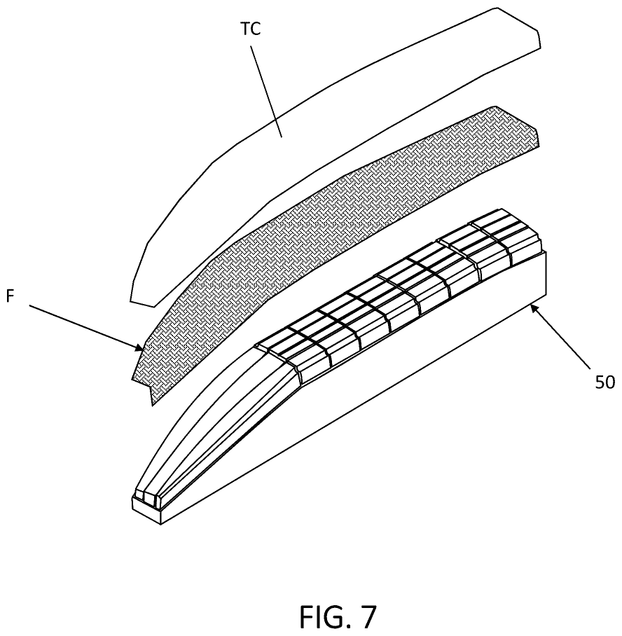

Having described an exemplary embodiment of an RTM system 10, this disclosure now turns to an exemplary process for making composite parts using the illustrated RTM system. Referring to FIGS. 6-7, the process begins by forming a fiber preform F on a transfer plate 18 while the transfer plate is supported on a preforming base 14. Because the fiber preform F docs not need to be assembled in an open mold, the step of forming the fiber preform can be conducted in an ambient temperature environment. In the illustrated embodiment, the RTM system 10 is configured for forming an aircraft fuselage component C (see. FIG. 10) comprising a skin panel Cl with integrated longeron beams C2 and a grid C3 for supporting a floor structure (the floor structure is a separate component of the aerostructure). Accordingly, forming the illustrated fiber preform F comprises wrapping fiber material onto one or more mandrels M (which define the recesses in the floor grid C3 above the skin panel C1) and using one or more indexing formations 86 of the transfer plate to locate each wrapped mandrel at a predefined location on the transfer plate. Additionally, the fibrous material wrapped around the mandrels M may be used to form portions of the floor grid C3 and additional fibrous material may be laid up on the fiber preform F to form the longeron beams C2, before laying final sheets of fibrous material to form the skin panel C1. After the fiber preform F is fully assembled on the transfer plate 18, the manufacturer can optionally place a temporary cover TC (FIG. 7) over the fiber preform to protect the fiber preform from dust and other contaminants. In certain embodiments, the temporary cover TC is impervious to air so that the space between the temporary cover and the transfer plate 18 can be evacuated to compact the fiber preform and/or assist with drying.

After assembling the fiber preform F on the transfer plate 18 and covering it with the temporary cover TC, the manufacturer next moves the preforming base 14 to the preheating system 16 and preheats the fiber preform to a molding temperature. In this embodiment, the preforming base 14, transfer plate 12, and fiber preform F are conveyed together through a preheating system 16. Thus, the preheating step results in each of the preforming base 14, transfer plate 12, and fiber preform F being heated to the molding temperature. It will be understood, however, that other embodiments can heat the fiber preform and the transfer plate to the molding temperature in a different way without departing from the scope of the disclosure.

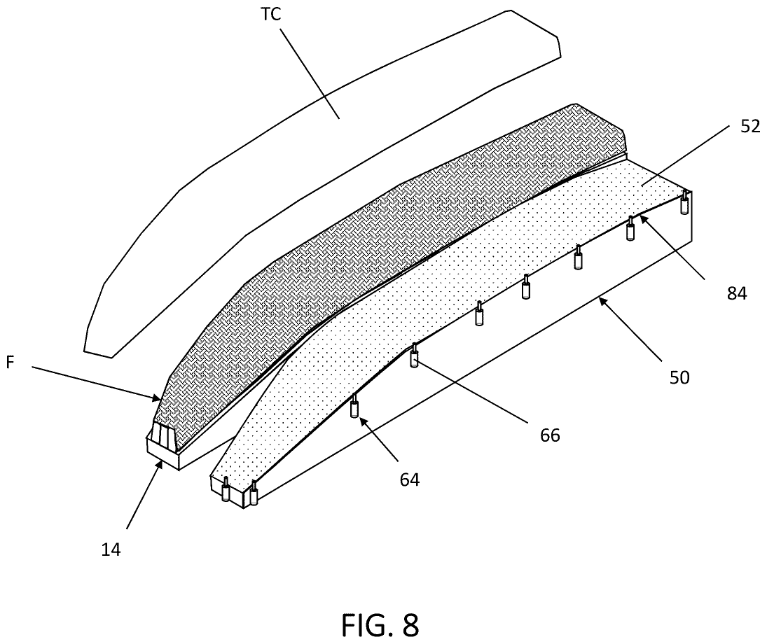

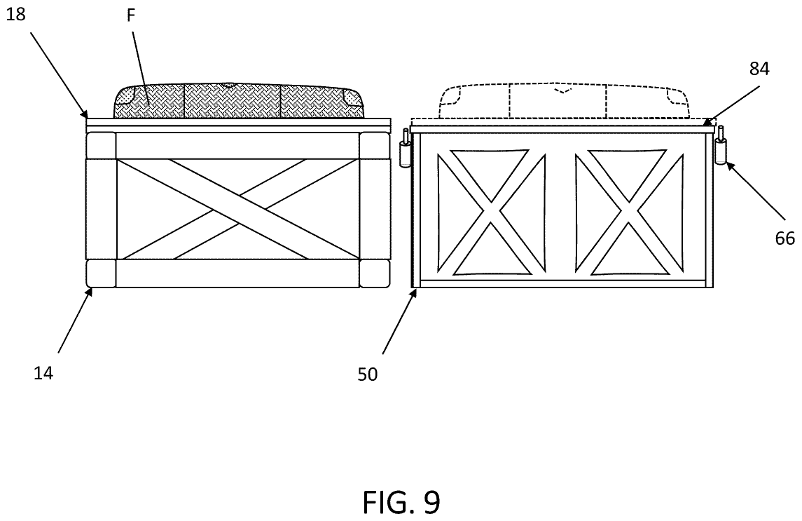

Referring to FIGS. 8-9, once the fiber preform F has been preheated, the manufacturer moves the heated assembly (including the heated preforming base, heated transfer plate, and heated fiber preform) to the RTM mold 12, opens the mold, and transfers the heated transfer plate 18 and fiber preform F together onto the RTM base. More particularly, the manufacturer activates the air bearing system of the preforming base 14 and the air bearing system of the RTM base 50 to lift the transfer plate and the fiber preform F as the transfer plate is slid from the preforming base to the RTM base. When the transfer plate 18 is at the proper position on the RTM base 50, the air bearing systems are turned off so that the transfer plate is stably supported on the RTM base. In an exemplary embodiment, immediately before the new preheated assembly is loaded onto the RTM base 50, a preceding composite part in the RTM mold 12, which would have just finished curing, is transferred out of the RTM mold 12 to a second preforming base 14.

Referring again to FIGS. 4 and 5, with the transfer plate 18 and fiber preform F positioned on the RTM base, the manufacturer next closes the RTM mold 12 to enclose the fiber preform F in the mold. In this case, the mold tool 56 is moved downward toward the RTM base 50 until the perimeter flange 60 of the mold tool rests on the transfer plate 18. Then the clamping system 64 is actuated to clamp the perimeter flange 60 against the transfer plate 18. This compresses the gasket 62 and seals the mold tool 56 against the transfer plate 18 so that a vacuum can be pulled in the mold cavity 59.

While the RTM mold 12 is closed, the composite part C is formed on the transfer plate 18 in the mold cavity 59. In general, forming the composite part C comprises infusing the fiber preform F with resin in the closed RTM mold 12 and curing the infused resin in the closed RTM mold to form the composite part. During the infusion step, the resin infusion system 70 pumps resin into the fiber preform F. In an exemplary embodiment, at least some of the resin is pumped and directed into the fiber preform F through the resin distribution grooves 88 formed in the transfer plate 18. While the resin infusion system 70 pumps in resin under positive pressure, the vacuum system 72 simultaneously pulls a vacuum through the fiber preform to assist with fully distributing resin through the fiber preform. In one or more embodiments (not shown), at least some of the vacuum is achieved by drawing gas out of the mold cavity through vacuum distribution grooves formed in the transfer plate.

In an exemplary embodiment, one or both of the infusion and curing steps conducted in the closed RTM mold 12 are an isothermal process conducted at an elevated temperature. The heaters 76 are active throughout the process (e.g., controlled thermostatically) to maintain the support surface 184, tooling surface 58, and chassis 182 at elevated molding temperatures. After resin infusion is complete, the heaters 76 continue to operate for as long as is required to cure the composite part C.

During both the resin infusion step and the curing step, the RTM mold 12 is closed. However, because of the way the transfer plates 18 are used in the RTM system 10, another fiber preform F can be prepared while the mold is closed. That is, while the RTM mold 12 is occupied infusing and curing one composite part, the fiber preform F for another composite part to be made in the very same RTM mold can be formed on a different transfer plate 18 (supported on a preforming base 14) and heated using the above described process. That way, as soon as the first composite part C is cured and demolded, the next fiber preform F can be loaded into the RTM mold 12. It can be seen, therefore, how the above-described RTM system 10 greatly increases the production rate of a single RTM mold when compared with conventional RTM systems that required fiber preforms to be assembled in the open mold.

After the composite part C has been formed and cured, the RTM mold 12 is opened and the transfer plate 18 supporting the composite part is moved from the RTM base 50 back onto the preforming base 14. Again, the air bearing systems are preferably activated to float the transfer plate 18 and composite part C as they are moved from one base to the other. Referring to FIG. 10, the preforming base 14 is then moved with the transfer plate 18 and composite part C to the composite part completion cell 20. In the composite part completion cell 20, the composite part C and transfer plate 18 are temporarily strapped to the preforming base 14, and the preforming base is coupled to the rotator 92. The rotator 92 then inverts the preforming base 14, transfer plate 18, and composite part C so that the manufacturer can position the composite part disassembly base 98 under the inverted composite part. Through engagement with the mandrels M, the indexing formations 86 on the transfer plate 18 help hold the composite part C in place during rotation in order to prevent dramatic changes in the direction of pressure applied to the composite part. The composite part C is then unstrapped from the transfer plate 18 and preforming base 14 and loaded onto the composite part disassembly base 98. The rotator 92 may rotate the preforming base 14 and transfer plate 18 back to the upright position and release them for use elsewhere in the RTM system. The robot 94 then removes the mandrels M from the composite part C onto the conveyor 96, and the conveyor conveys the removed mandrels to a separate area where they can be cleaned (e.g., by carbon dioxide blasting) for reuse.

The RTM system 10 and process of the present disclosure provides notable advantages over conventional RTM systems for large, complex composite parts like aerostructures. In terms of manufacturing throughput, improvement is achieved because workers need not repeatedly assemble fiber preforms in an open RTM mold or wait for the RTM mold to change temperature. Rather, because the transfer plate 18 facilitates transfer of a fully assembled fiber preform F, a worker can perform assembly outside of an open RTM mold. This not only increases the potential throughput, but reduces the risk of discomfort and injury which may result from working in a hot open RTM mold. In addition, the RTM mold can remain closed essentially anytime except when a pre-assembled fiber preform is loaded into the mold or when a completed composite part is demolded. The normally-closed RTM mold can be heated continuously, allowing for an isothermal process, which further increases throughput because time spent preheating the mold prior to resin infusion and curing is substantially eliminated. The temporary cover TC can also enable consolidation and drying of the fiber preform prior to loading into the RTM mold 12, further reducing the amount of time the RTM mold is needed for the process. The isothermal RTM process may also yield meaningful reductions in energy consumption. In sum, the RTM system 10 enables an RTM mold 12 to be completely dedicated to its fundamental tasks of resin infusion and curing, and all other major aspects of the RTM molding process are handled outside the mold.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method for resin transfer molding (RTM) a composite part, the method comprising:
forming a fiber preform on a transfer plate while the transfer plate is supported on a preforming base;
transferring the transfer plate and the fiber preform together from the preforming base to an RTM base of an RTM mold;
closing the RTM mold to enclose the fiber preform in the RTM mold;
while the RTM mold is closed, forming the composite part on the transfer plate in the RTM mold, said forming the composite part comprising:
infusing the fiber preform with resin in the closed RTM mold; and
curing the infused resin in the closed RTM mold to form the composite part;
opening the RTM mold; and
removing the transfer plate and composite part together from the mold.

2. The method of claim 1, further comprising forming another composite part on another transfer plate in the RTM mold while forming the fiber preform.

3. The method of claim 1, further comprising preheating the fiber preform and the transfer plate before transferring the transfer plate and the fiber preform together to the RTM base of the RTM mold, wherein said forming the composite part is an isothermal RTM process.

4. The method of claim 1, wherein said forming the fiber preform comprises forming the fiber preform in an ambient temperature environment.

5. The method of claim 1, wherein said forming the fiber preform comprises wrapping fiber material onto one or more mandrels and using one or more indexing formations of the transfer plate to locate each mandrel at a predefined location on the transfer plate.

6. The method of claim 1, wherein said transferring comprises activating an air bearing of the preforming base and an air bearing of the RTM base to lift the transfer plate and the preform as the transfer plate is slid from the preforming base to the RTM base.

7. The method of claim 1, wherein said infusing the fiber preform with resin comprises directing resin into the fiber preform through a resin distribution groove formed in the transfer plate.

8. The method of claim 1, wherein said infusing the fiber preform with resin comprises drawing a vacuum in the fiber preform through a vacuum distribution groove formed in the transfer plate.

9. The method of claim 1, wherein said closing the RTM mold comprises sealing a mold tool of the RTM mold against the transfer plate.

10. The method of claim 1, wherein said closing the RTM mold comprises clamping a mold tool of the RTM mold against the transfer plate.

11. A resin transfer molding (RTM) system for forming composite parts, the RTM system comprising:
an RTM mold comprising an RTM base, the RTM mold having an open position and a closed position;
a preforming base outside of the RTM mold; and
a transfer plate movable between a preforming position on the preforming base and a molding position on the RTM base, the transfer plate configured to support a fiber preform constructed on the transfer plate while the transfer plate is in the preforming position, the transfer plate being movable from the preforming position to the molding position when the RTM mold is in the open position to load the fiber preform into the RTM mold, the transfer plate configured to support the fiber preform in the RTM mold at the molding position while the RTM mold is in the closed position whereby the transfer plate positions the fiber preform for resin infusion and curing in an RTM process.

12. The RTM system of claim 11, wherein the transfer plate comprises one or more indexing formations for aligning the fiber preform on the transfer plate at a predefined position.

13. The RTM system of claim 11, wherein the transfer plate comprises a top surface and a resin distribution groove formed in the top surface.

14. The RTM system of claim 11, wherein the transfer plate comprises a top surface and a vacuum distribution groove formed in the top surface.

15. The RTM system of claim 11, further comprising a preheating system outside the RTM mold, the preforming base positionable in relation to the preheating system for preheating the transfer plate and fiber preform together before loading the fiber preform into the RTM mold such that the RTM process is isothermal.

16. The RTM system of claim 11, wherein the RTM mold comprises a mold tool movable in relation to the RTM base between an open position and a closed position, wherein the RTM mold and the transfer plate are configured to define a mold cavity when the transfer plate is supported on the RTM base and the mold tool is in the closed position.

17. The RTM system of claim 16, wherein the RTM mold comprises a gasket on the mold tool configured sealingly engage the transfer plate and make a vacuum seal between the transfer plate and the mold tool.

18. The RTM system of claim 16, further comprising a clamping system configured to clamp the mold tool against the transfer plate when the transfer plate is supported on the RTM base and the mold tool is in the closed position.

19. The RTM system of claim 11, further comprising at least one other identical transfer plate.

20. The RTM system of claim 11, wherein each of the preforming base and the RTM base comprises a respective air bearing system.
